(19) United States
(12) Patent Application Publication
(10) Pub. No.: US 2004/0261957 A1
(43) Pub. Date: Dec. 30, 2004

(54) Blinds coated with photo catalyst

(76) Inventor: Chin-Fu Chen, Changhua Hsien (TW)

Correspondence Address: BIRCH STEWART KOLASCH & BIRCH, PO BOX 747, FALLS CHURCH, VA, 22040-0747, US

(21) Appl. No.: 10/602,718

(22) Filed: Jun. 25, 2003

(51) Int. Cl. E06B 3/12

(52) U.S. Cl. 160/236

(57) ABSTRACT

A blind coated with photo catalyst consists of slats and a protective layer of photo catalyst coating on the surface of the slats. The protective layer receives projection of a light source (such as ultraviolet light) and is agitated to release free radicals to decompose and absorb organic substances in the air to eliminate toxic chemical substances in the air.

### FIELD OF THE INVENTION

The present invention relates to blinds and particularly to a blind coated with photo catalyst.

### BACKGROUND OF THE INVENTION

In recent years, due to destroying of ozone layer in the atmosphere, worldwide temperature increases continuously. These days modern houses and offices, aside from having air conditioning, window coverings (such as blinds) also are widely used to prevent high temperature from directly projecting into the rooms so that the performance of air conditioning may be improved. For countries situated in the subtropical area that has island type weather, the climate temperature is usually high and the air is often humid. Germs breed easily. As a result, illness such as asthma, allergic rhinitis, and skin diseases tend to infest frequently. The crowded living environment also produces severe air pollution. In a closed environment, the quality of circulated air is very poor due to the organic materials contained in the window coverings (such as blinds).

Moreover, at present the window coverings (such as blinds) are mostly being used to block sunshine. There is no much added value. How to increase the value of the window coverings such as automatically cleaning the air, disinfecting, contamination preventing and deodorizing to improve the quality of air and environment has become a critical issue.

### SUMMARY OF THE INVENTION

The primary object of the invention is to resolve the aforesaid disadvantages and eliminate the drawbacks occurred to the prior art. The invention provides a blind that has a protective layer coating on the slats of the blind. The protective layer can decompose and eliminate harmful organic substances around the slats to improve air quality.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of the present invention before coating photo catalyst.

FIG. 2 is another schematic view of the present invention before coating photo catalyst.

FIG. 3 is a schematic view of the present invention after coating photo catalyst.

FIG. 4 is a diagram of the invention showing reaction of the photo catalyst.

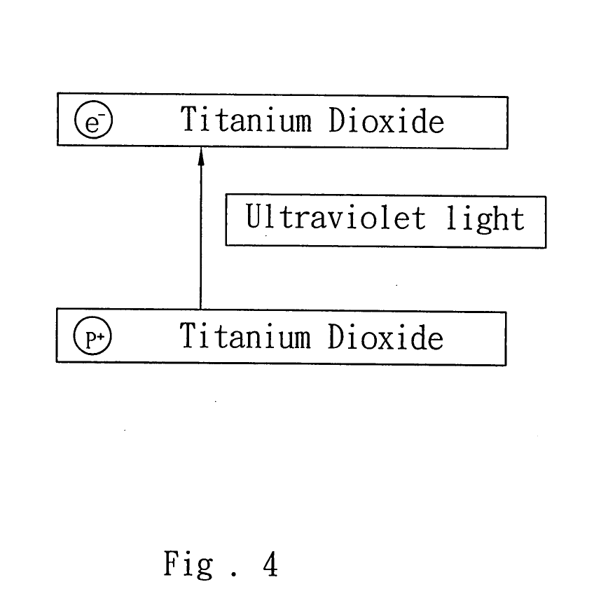

### DETAILED DESCRIPTION OF THE PREFERRED EMBODIMENT

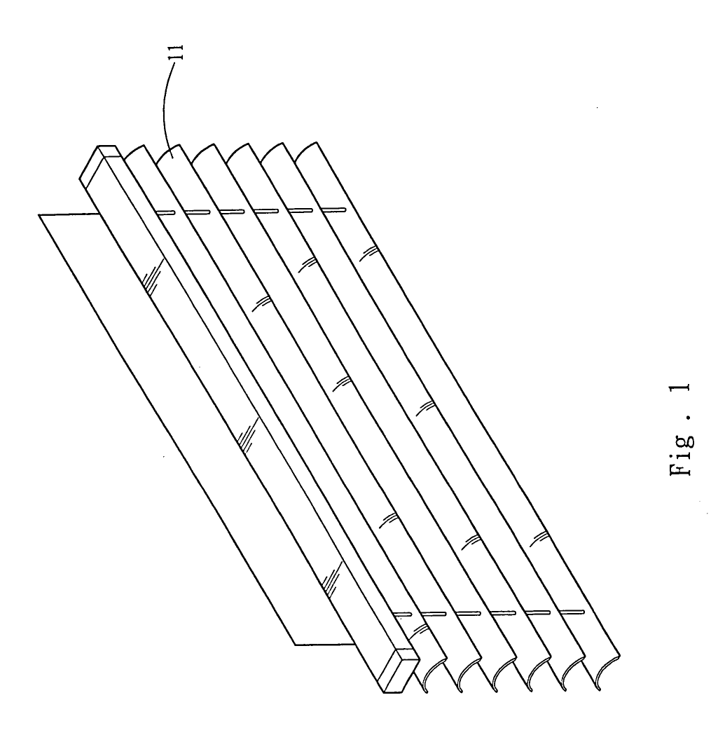

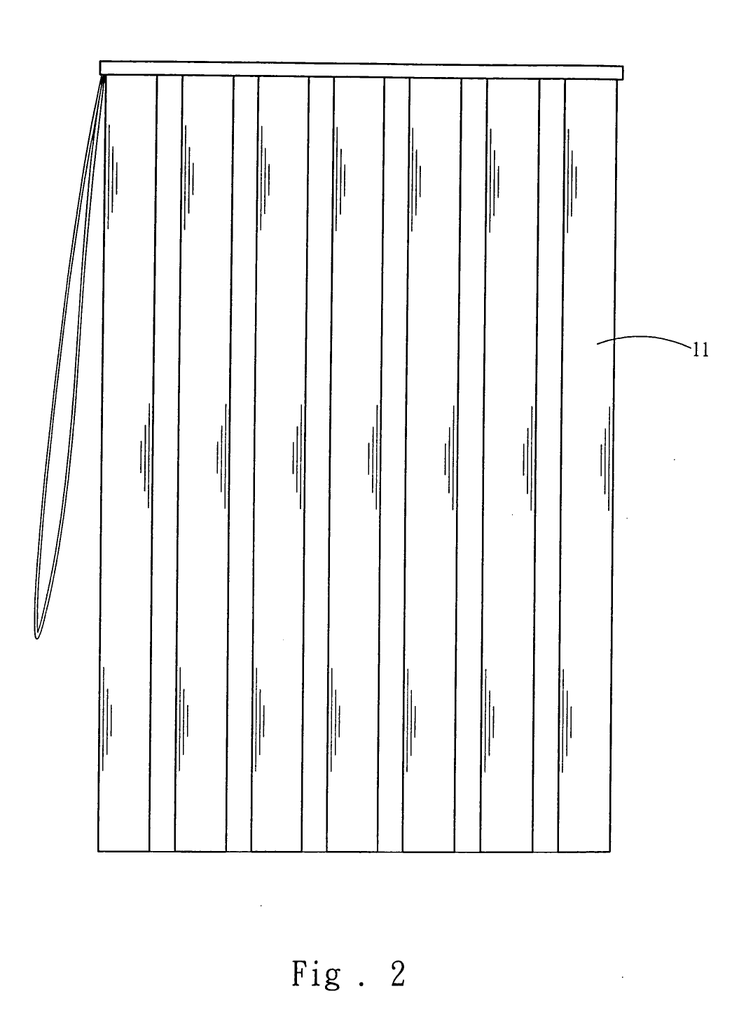

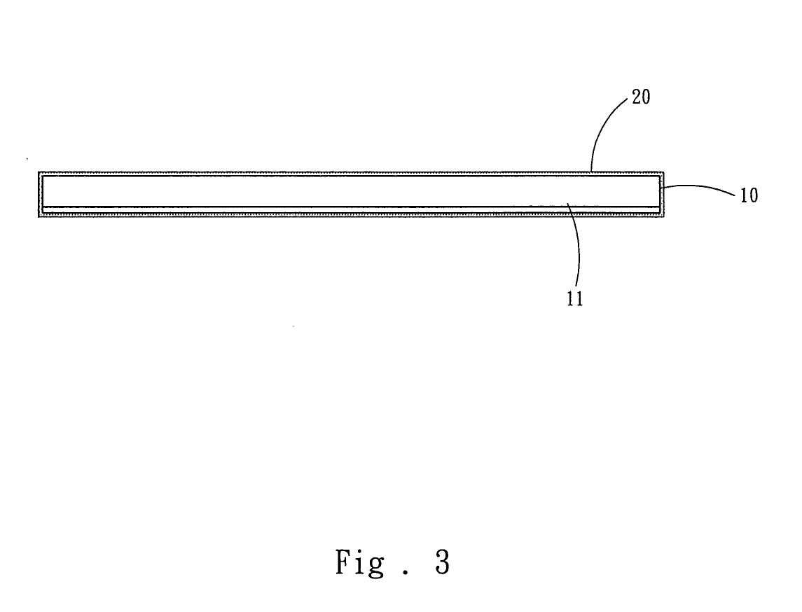

Please refer to FIGS. 1, 2 and 3 for the present invention before and after coating photo catalyst.

The blind according to the invention mainly includes slats 11 which are coated with photo catalyst 10 by spraying or plating to form a protective layer 20.

The photo catalyst is made from a compound and oxide such as Titanium Dioxide (TiO₂) in the nanometer degree that has a strong oxidized reduction power and is chemically stable and toxic-free.

Upon the surface of the Titanium Dioxide (TiO₂) of nanometer degree being projected by ultraviolet light, the electrons on the surface that have received enough energy can escape from the surface and the surface forms a positive hole carrying a positive charge. The positive hole has a strong oxidation power and can snatch electrons from a charged ionized radical in the moisture of the air. When the electrons in the ionized radical are taken away, the ionized radical becomes a unstable free radical. When the unstable free radical encounters an organic substance in the environment, it can capture electrons from the surface of the organic substance to become stable again. When the organic substance loses electrons, it breaks apart and vanishes in the air.

Based on the technique set forth above, the window covering (such as blinds) can be made with more added value. Aside from blocking sunshine, it also can provide functions such as automatically cleaning air, disinfecting, contamination preventing and deodorizing. The technique employed in the invention is to coat by spraying or plating photo catalyst 10 made from Titanium Dioxide (TiO₂) of nanometer degree on the surface of the slats 11 of the blind to form a protective layer 20. When the protective layer 20 receives external light projection (such as ultraviolet light), the “free radical” decomposes and absorbs the organic substances in the air (such as carbon oxide, sulphur oxide, ammonia, sulphur, acetaldehyde generated by germs, contaminated objects and ozone). Thus toxic chemical substances in the air may be eliminated. As a result, the slats 11 of the blind of the invention can automatically remove the toxic materials in the air and improve air quality in the environment.

1. A blind coated with photo catalyst comprising slats and a protective layer of photo catalyst coating on the surface of the slats, the protective layer receives projection of a ultraviolet light source and is agitated to release free radicals to decompose and absorb organic substances in the air to eliminate toxic chemical substances in the air.

2. The blind of claim 1, wherein the photo catalyst is Titanium Dioxide (TiO2).

3. The blind of claim 1, wherein the photo catalyst is coated on the surface of the slats by spraying.

4. The blind of claim 1, wherein the photo catalyst is coated on the surface of the slats by plating.

5. A blind comprising at least one slat and means on the slat for reacting with ultraviolet light to release free radicals which absorb organic substances in the air to eliminate toxic chemical substances in the air, the means for reacting including a layer of photo catalyst coating on a surface of the at least one slat.

6. The blind of claim 5, wherein the at least one slat includes a plurality of slats and wherein more than one of the slats have the photo catalyst coating thereon.

7. The blind of claim 6, wherein the photo catalyst is Titanium Dioxide (TiO2).

8. The blind of claim 5, wherein the photo catalyst is Titanium Dioxide (TiO2).

9. The blind of claim 5, wherein the photo catalyst is coated on the surface by spraying.

10. The blind of claim 5, wherein the photo catalyst is coated on the surface by plating.
